(19) United States
(12) Patent Application Publication
(10) Pub. No.: US 2016/0266618 A1
(43) Pub. Date: Sep. 15, 2016

(54) Chassis for industrial PC

(71) Applicant: Kuo Hsin WANG, New Taipei City (TW)

(72) Inventor: Kuo Hsin WANG, New Taipei City (TW)

(21) Appl. No.: 14/656,728

(22) Filed: Mar. 13, 2015

(51) Int. Cl. G06F 1/18

(52) U.S. Cl. CPC G06F 1/181

(57) ABSTRACT

A chassis for an industrial PC comprising: a bottom plate, a first side plate, a second side plate, a top plate, a front plate, and a back plate. Any one of the first side plate, the second side plate, the front plate and the back plate is connected with any one of the bottom plate and the top plate by using at least one coupling element. The at least one coupling element includes at least one connection orifice and at least one screwing orifice defined on each of the bottom plate and the top plate, at least one screw bolt and an insert tenon arranged on each of the first side plate, the second side plate, the front plate, and the back plate. Each insert tenon is inserted into each connection orifice, and each screw bolt is screwed with each screwing orifice.

### FIELD OF THE INVENTION

The present invention relates to a chassis for an industrial PC which is assembled and disassembled easily based on using requirement.

### BACKGROUND OF THE INVENTION

A conventional chassis for an industrial PC is employed to accommodate motherboards, disks, power supplies, and interface cards. However, the chassis is assembled in a fixed size, thus delivering the chassis inconveniently.

The present invention has arisen to mitigate and/or obviate the afore-described disadvantages.

### SUMMARY OF THE INVENTION

The primary objective of the present invention is to provide a chassis for an industrial PC which is assembled and disassembled easily based on using requirement.

Another objective of the present invention is to provide a chassis for an industrial PC which is disassembled to be portable easily.

To obtain above objectives, a chassis for an industrial PC provided by the present invention contain: a bottom plate, a first side plate, a second side plate, a top plate, a front plate, and a back plate.

Any one of the first side plate, the second side plate, the front plate and the back plate is connected with any one of the bottom plate and the top plate by using at least one coupling element to form a chassis with an accommodating chamber in the chassis.

The at least one coupling element includes at least one connection orifice and at least one screwing orifice defined on each of the bottom plate and the top plate, at least one screw bolt and an insert tenon arranged on each of the first side plate, the second side plate, the front plate, and the back plate, wherein each insert tenon is inserted into each connection orifice, and each screw bolt is screwed with each screwing orifice.

Preferably, the bottom plate includes a first body, a peripheral rib, a first connecting rim, and at least one connection orifice, wherein the first body has a first face and a second face opposite to the first face, and the peripheral rib has at least one screwing orifice defined thereon; the first connecting rim is defined between the peripheral rib and the first body to connect with the peripheral rib and the first body, and a first bending segment is formed on a connection area of the first connecting rim and the first body, such that a first bottom face of the first connecting rim flushes with the first face of the first body, and the at least one connection orifice passes through the first bending segment; each of the first side plate and the second side plate includes a second body, a second connecting rim, and at least one insert tenon, wherein the second body has at least one bolt screw inserted therein, the at least one insert tenon is inserted into the at least one connection orifice of the bottom plate, and the second connecting rim is defined between the second body and the at least one insert tenon to couple with the second body and the at least one insert tenon, a second bending segment is defined on a connection area of the second connecting rim and the at least one insert tenon, wherein after the at least one insert tenon is inserted into the at least one connection orifice, a top face of the second connecting rim contacts with the first bottom face of the first connecting rim, a second bottom face of each insert tenon contacts with the first face of the first body, and an internal face of the second body contacts with an external face of the peripheral rib, thereafter the at least one screw bolt is screwed with the at least one screwing orifice.

Preferably, the connection rim is elongated.

Preferably, the bottom plate is formed from a metal material, and the connection rim and the connecting rib extend outwardly from one side of the first body, wherein the connecting rib is bent to form an angle between the connecting rib and the first body.

Preferably, the angle is a right angle.

### BRIEF DESCRIPTION OF THE DRAWINGS

FIG. 1 is a perspective view showing the exploded components of a chassis for an industrial PC according to a preferred embodiment of the present invention.

FIG. 2 is a perspective view showing the exploded components of a part of the chassis for the industrial PC according to the preferred embodiment of the present invention.

FIG. 3 is an amplified perspective view of a portion A of FIG. 2.

FIG. 4 is a side plane view showing the assembly of the chassis for the industrial PC according to the preferred embodiment of the present invention.

FIG. 5 is an amplified plan view of a portion B of FIG. 4.

FIG. 6 is a side plan view showing the operation of a part of the chassis for the industrial PC according to the preferred embodiment of the present invention.

FIG. 7 is a perspective view showing the assembly of the chassis for the industrial PC according to the preferred embodiment of the present invention.

### DETAILED DESCRIPTION OF THE PREFERRED EMBODIMENTS

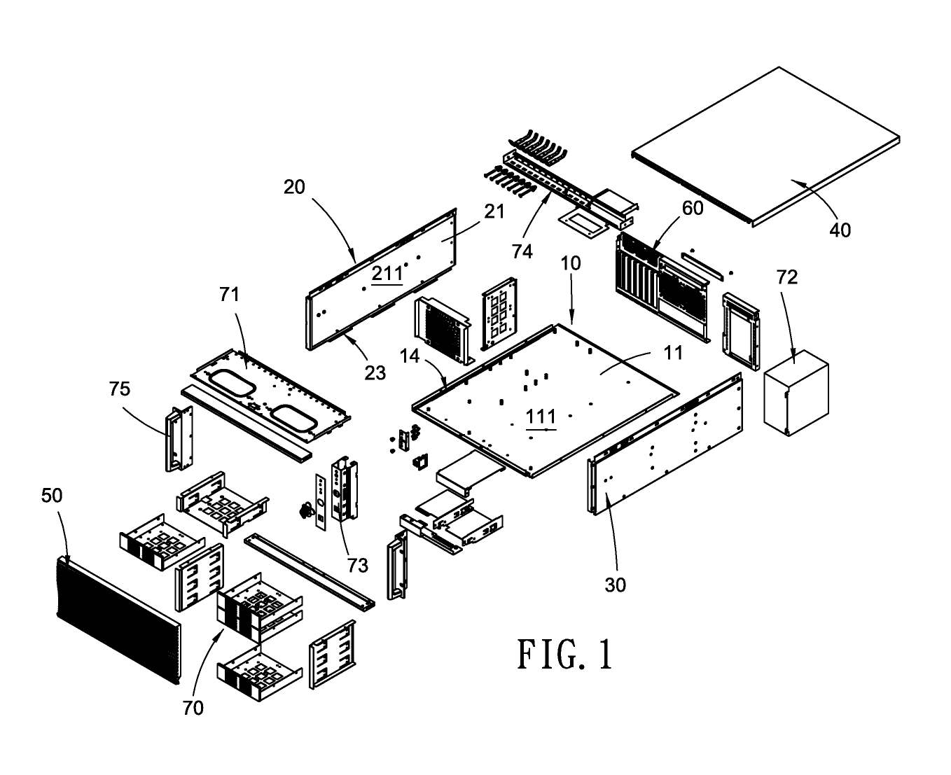

With reference to FIGS. 1 to 3, a chassis for an industrial PC according to a preferred embodiment of the present invention comprises: a bottom plate 10, a first side plate 20, a second side plate 30, a top plate 40, a front plate 50, and a back plate 60.

In general, a length and a width of the chassis are standardized, and a height of the chassis is measured by an unit U (i.e., 1 U=1.75 inch), such that a height of each of the first side plate 20, the second side plate 30, the front plate 50, and the back plate 60 is measured by the unit U (such as 1 U, 2 U, 3 U, and so on).

The chassis of the present invention is assembled by using at least one coupling element, such as at least one screw bolt for matching with at least one threaded hole or at least one insert tenon for cooperating with at least one insertion orifice (their detail information is described hereafter). For example, any one of the first side plate 20, the second side plate 30, the front plate 30, and the back plate 60 is connected with or removed from any one of the bottom plate 10 and the bottom plate 40 to form the chassis with an accommodating chamber in the chassis, thus assembling the chassis of various sizes easily.

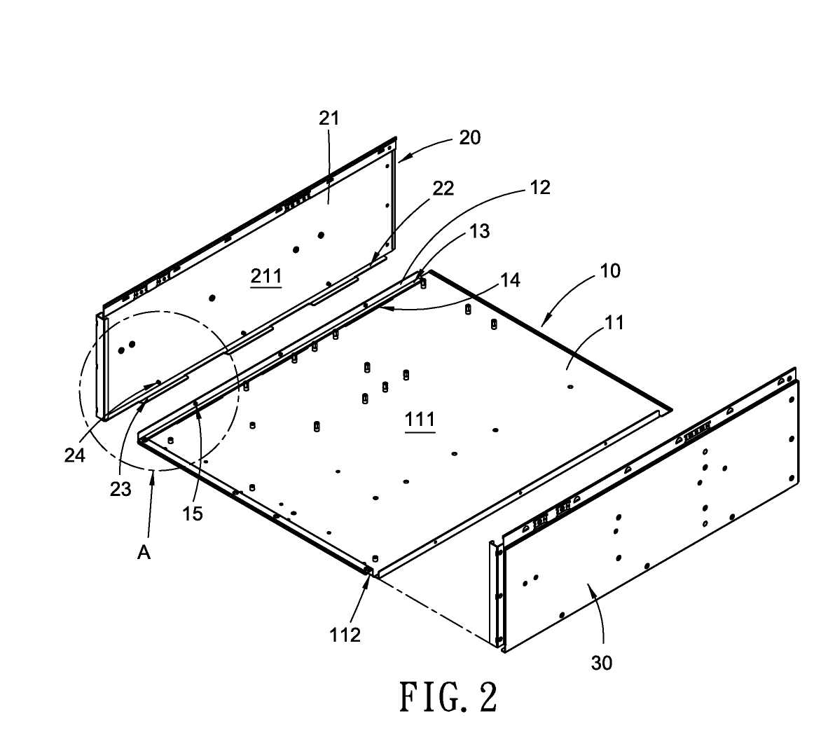

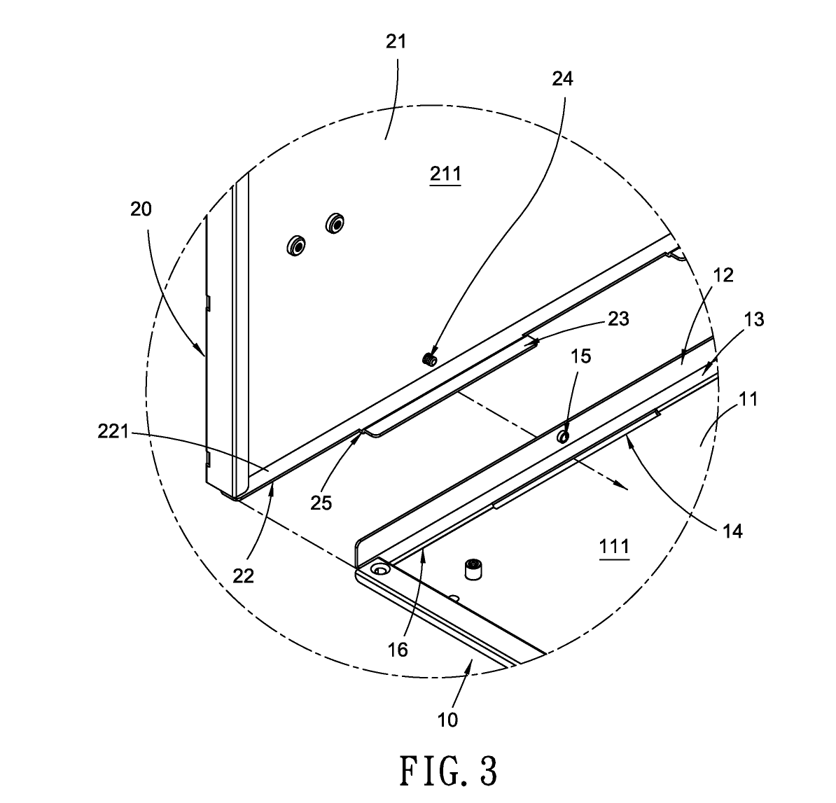

Referring to FIGS. 2 and 3, the bottom plate 10 is connected with or is removed from the first side plate 20 and the second side plate 30. As shown in FIGS. 1 to 4, the first side plate 20 is symmetrical to the second side plate 30, and structures of the first side plate 20 and the bottom plate 10 are the seam and are described hereafter.

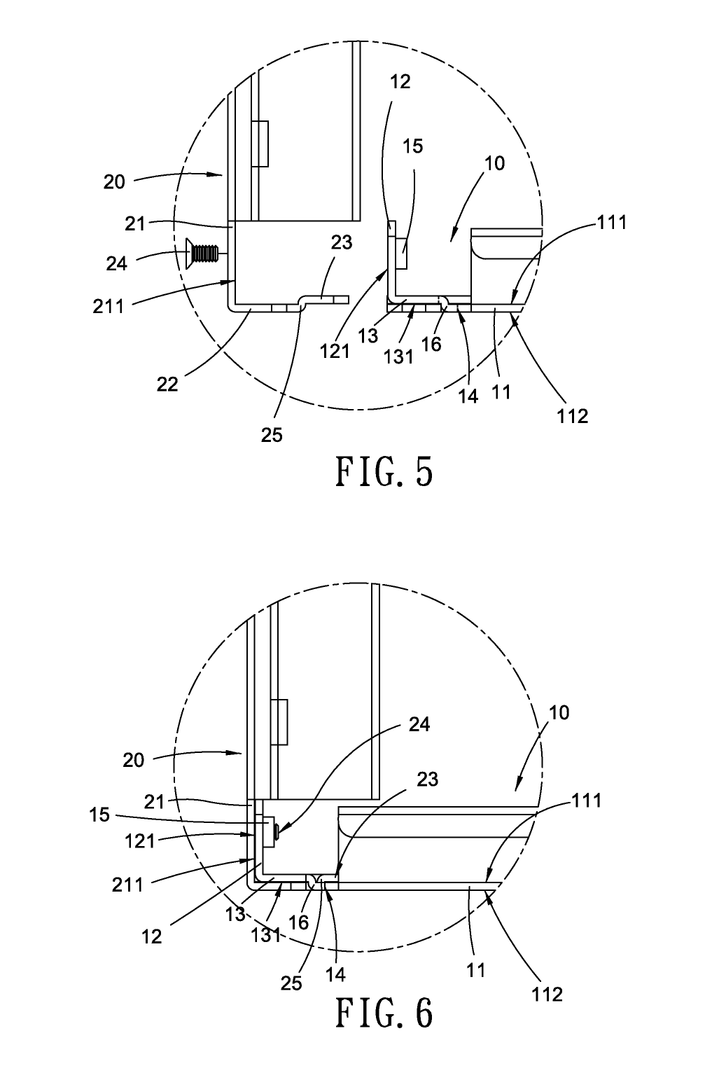

The bottom plate 10 includes a first body 11, a peripheral rib 12, a first connecting rim 13, and at least one connection orifice 14, wherein the first body 11 has a first face 111 and a second face 112 opposite to the first face 112 (as shown in FIG. 5), and the peripheral rib 12 has at least one screwing orifice 15 defined thereon; the first connecting rim 13 is defined between the peripheral rib 12 and the first body 11 to connect with the peripheral rib 12 and the first body 11, and a first bending segment 16 is formed on a connection area of the first connecting rim 13 and the first body 11, such that a first bottom face 131 of the first connecting rim 13 flushes with the first face 111 of the first body 11, and the at least one connection orifice 14 passes through the first bending segment 16, wherein the connection rim 13 is elongated, the bottom plate 10 is formed from a metal material, and the connection rim 13 and the connecting rib 12 extend outwardly from one side of the first body 11, wherein the connecting rib 12 is bent to form an angle between the connecting rib 12 and the first body 11, and the angle is a right angle.

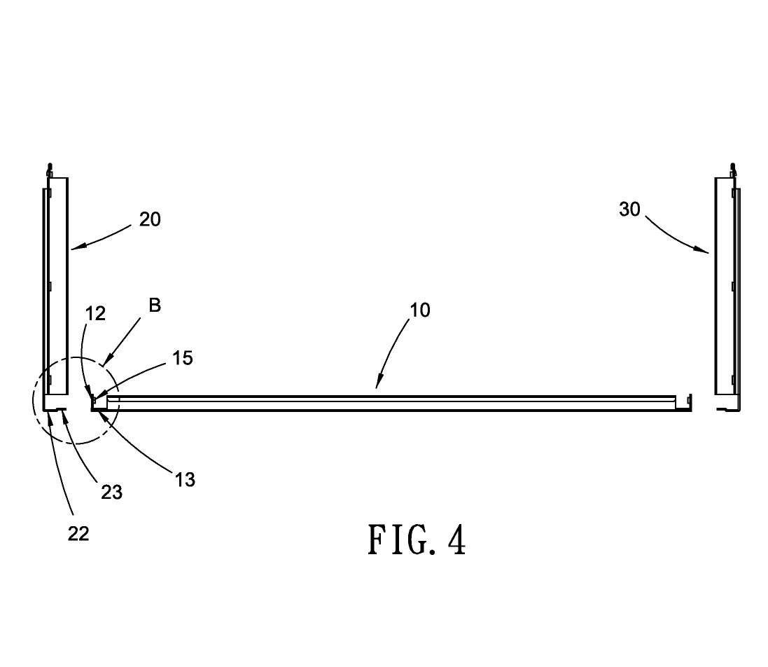

The first side plate 20 includes a second body 21, a second connecting rim 22, and at least one insert tenon 23, wherein the second body 21 has at least one bolt screw 24 inserted therein (as illustrated in FIG. 5), the at least one insert tenon 23 is inserted into the at least one connection orifice 14 of the bottom plate 10, and the second connecting rim 22 is defined between the second body 21 and the at least one insert tenon 23 to couple with the second body 21 and the at least one insert tenon 23, a second bending segment 25 is defined on a connection area of the second connecting rim 22 and the at least one insert tenon 23, wherein after the at least one insert tenon 23 is inserted into the at least one connection orifice 14, a top face 221 of the second connecting rim 22 contacts with the first bottom face 131 of the first connecting rim 13 (as shown in FIGS. 5 and 6), a second bottom face 231 of each insert tenon 23 contacts with the first face 111 of the first body 11, and an internal face 211 of the second body 21 contacts with an external face 121 of the peripheral rib 12, thereafter the at least one screw bolt 24 is screwed with the at least one screwing orifice 15, thus connecting the first side plate 20 with the bottom plate 10 (as shown in FIG. 5). As desiring to remove the first side plate 20 from the bottom plate 10, the at least one screw bolt 24 is unscrewed from the at least one screwing orifice 15, and the at least one insert tenon 23 is removed from the at least one connection orifice 14, thus removing the first side plate 20 from the bottom plate 10 (as illustrated in FIG. 4).

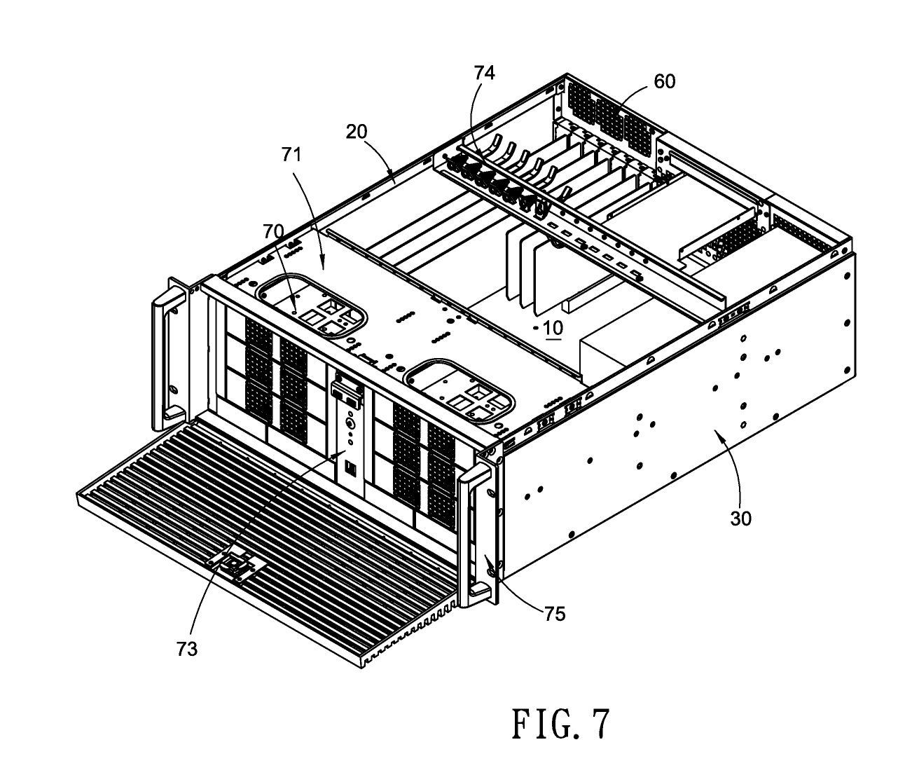

The chassis further comprises: at least one vertically magnetic rack 70 and at least one stop piece 71 (as shown in FIG. 1), wherein the at least one vertically magnetic rack 70 and the at least one stop piece 71 are connected together by ways of any one of at least one screw bolt, at least one insert tenon, and at least locking pin. Thereby, the chassis of the present invention is assembled and disassembled easily. Preferably, as shown in FIGS. 1 and 7, the chassis further comprises: a first support mount 72 for supporting a power supply, a second support mount 73 for fixing power switch and a lock, and a third support mount 74 for accommodating electronic components of the industrial PC, and a handle 75.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A chassis for an industrial PC comprising: a bottom plate, a first side plate, a second side plate, a top plate, a front plate, and a back plate; wherein
any one of the first side plate, the second side plate, the front plate and the back plate is connected with any one of the bottom plate and the top plate by using at least one coupling element to form a chassis with an accommodating chamber in the chassis;
the at least one coupling element includes at least one connection orifice and at least one screwing orifice defined on each of the bottom plate and the top plate, at least one screw bolt and an insert tenon arranged on each of the first side plate, the second side plate, the front plate, and the back plate, wherein each insert tenon is inserted into each connection orifice, and each screw bolt is screwed with each screwing orifice.

2. The chassis for the industrial PC as claimed in claim 1, wherein the bottom plate includes a first body, a peripheral rib, a first connecting rim, and at least one connection orifice, wherein the first body has a first face and a second face opposite to the first face, and the peripheral rib has at least one screwing orifice defined thereon; the first connecting rim is defined between the peripheral rib and the first body to connect with the peripheral rib and the first body, and a first bending segment is formed on a connection area of the first connecting rim and the first body, such that a first bottom face of the first connecting rim flushes with the first face of the first body, and the at least one connection orifice passes through the first bending segment; each of the first side plate and the second side plate includes a second body, a second connecting rim, and at least one insert tenon, wherein the second body has at least one bolt screw inserted therein, the at least one insert tenon is inserted into the at least one connection orifice of the bottom plate, and the second connecting rim is defined between the second body and the at least one insert tenon to couple with the second body and the at least one insert tenon, a second bending segment is defined on a connection area of the second connecting rim and the at least one insert tenon, wherein after the at least one insert tenon is inserted into the at least one connection orifice, a top face of the second connecting rim contacts with the first bottom face of the first connecting rim, a second bottom face of each insert tenon contacts with the first face of the first body, and an internal face of the second body contacts with an external face of the peripheral rib, thereafter the at least one screw bolt is screwed with the at least one screwing orifice.

3. The chassis for the industrial PC as claimed in claim 2, wherein the connection rim is elongated.

4. The chassis for the industrial PC as claimed in claim 2, wherein the bottom plate is formed from a metal material, and the connection rim and the connecting rib extend outwardly from one side of the first body, wherein the connecting rib is bent to form an angle between the connecting rib and the first body.

5. The chassis for the industrial PC as claimed in claim 4, wherein the angle is a right angle.
